(19) United States
(12) Patent Application Publication
(10) Pub. No.: US 2021/0060971 A1
(43) Pub. Date: Mar. 4, 2021

(54) Tactile printing system and method

(71) Applicants: Navyansh Malhotra, SG (SG); Surya Somayyajula, Herndon, VA (US); Michelle Chang, SG (SG); Micheal Dooley, Redwood City, CA (US)

(72) Inventors: Navyansh Malhotra, SG (SG); Surya Somayyajula, Herndon, VA (US); Michelle Chang, SG (SG); Micheal Dooley, Redwood City, CA (US)

(21) Appl. No.: 16/779,580

(22) Filed: Feb. 1, 2020

Related U.S. Application Data
(60) Provisional application No. 62/892,591, filed on Aug. 28, 2019.

(51) Int. Cl. B41J 2/47; B41J 2/455

(52) U.S. Cl. CPC B41J 2/47; B41J 2/455

(57) ABSTRACT

This invention is a novel method for tactile printing which comprises of a low power energy source to heat temperature sensitive elements within a medium such as microcapsule paper.

### BACKGROUND OF THE INVENTION

The present invention is in the technical field of tactile printing. More particularly, the present invention is in the technical field of using a light-based heat source in combination with microcapsule paper, also known as swell paper, to produce tactile diagrams and images.

Current methods to produce tactile diagrams are incredibly hard to access for visually impaired and blind students due to a multitude of factors including but not limited to the high costs of capital equipment required and the labor-intensive process in hand drawing and producing a tactile diagram or image.

Tactile diagrams are a key requirement for visually impaired and blind students in their quest to peruse education, including but not limited to understanding scientific and mathematical concepts.

Therefore, a need exists for a novel method which is both affordable and accessible to easily produce tactile shapes, forms, diagrams and images.

### BRIEF SUMMARY OF THE INVENTION

Embodiments of the disclosure can be used to produce tactile diagrams and images. For example, a low power energy source can be used to heat temperature sensitive elements within a medium, hence ‘raising’ the path the output of the energy source moves in, forming tactile elements.

In an embodiment of the invention, low power laser(s) can be used to heat the ‘microcapsules’ also referred to as ‘alcohol microbubbles’ in the microcapsule paper.

In another embodiment, the laser moves on a 2-dimensional plane and the microcapsule paper is placed in a fixed position.

In another embodiment, the laser is placed in a fixed position and the microcapsule paper moves on a 2-dimensional plane.

### BRIEF DESCRIPTION OF THE DRAWINGS

Embodiments of the present invention are illustrated as an example but, are not limited by the figures of the accompanying drawings, in which like references indicate similar elements and in which:

FIG. 1 depicts a front perspective view of a tactile printing system, according to one embodiment.

FIG. 2 depicts the top perspective view of a tactile printing system, according to one embodiment.

FIG. 3 depicts a side perspective view of a tactile printing system, according to one embodiment.

FIG. 4 illustrates a sheet of microcapsule paper whilst undergoing tactile printing, according to one embodiment.

FIG. 5 illustrates a cross-section perspective of microcapsule paper having undergone tactile printing, according to one embodiment.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It is also understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

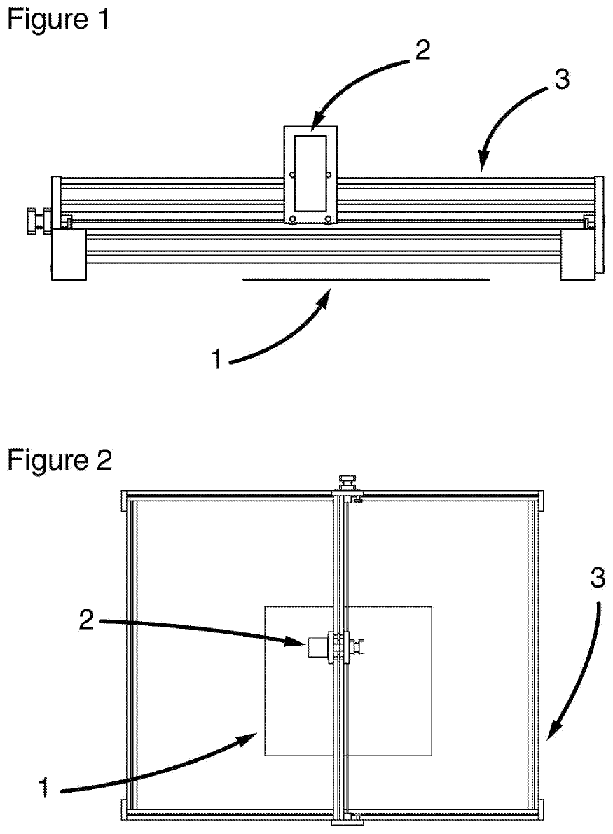

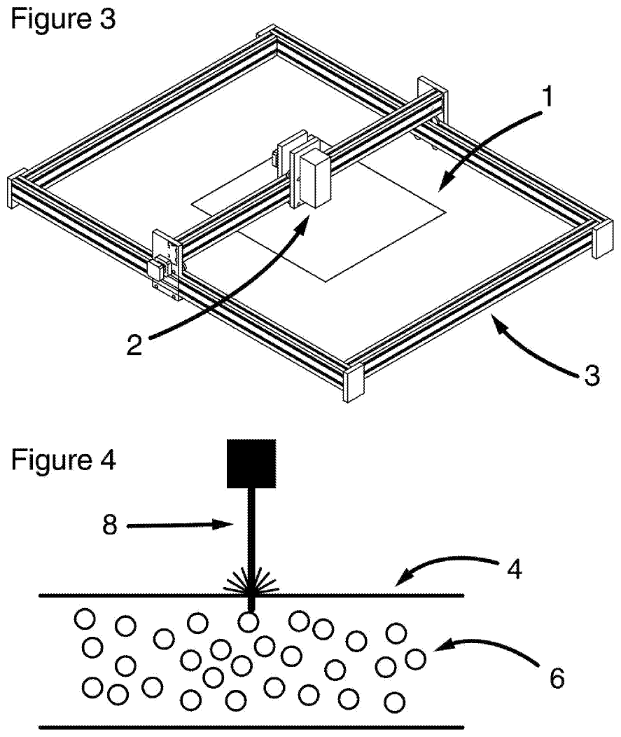

Referring now to the invention in more detail, as shown in FIG. 1, FIG. 2 and FIG. 3, the system comprises an energy source 2 and a support structure 3. A tactile printing medium 1, is positioned on the support structure 3, in a position such that it can be exposed to the energy output of the energy source 2.

The energy source 2 can be a laser light source, or other suitable energy source known to one of ordinary skill in the art which is capable of outputting a targeted energy toward the tactile printing medium 1. Embodiments of the present invention can include positioning the energy source in direct proximity of the tactile printing medium, as well as at a distance. The relative position of these elements will define the medium and method used to direct the output energy of the energy source to the tactile printing medium. Example methods for directing the output can include but are not limited to lasers, light bulbs, lenses, fiber optics and other energy sources.

There are various arrangements of the laser 2 and the microcapsule paper 1 that allow of the same results, including but not limited to; (arrangement 1) the laser 2 moves on a 2-dimensional plane in the ‘X’ and ‘Y’ axis, and the sheet of microcapsule paper 1 is placed in a fixed position for the duration of the ‘process’, referring to the method claimed in this invention. The second arrangement (arrangement 2) refers to where the microcapsule paper 1 moves on a 2-dimensional plane in the ‘X’ and ‘Y’ axis, and the laser 2 is placed in a fixed position for the duration of the ‘process’, referring to the method claimed in this invention.

In FIG. 1, FIG. 2 and FIG. 3, the chassis 3 as used in the illustrated embodiment of this invention is shown. The chassis can be constructed of any suitable material, including but not limited to metals, woods and plastics. The chassis arrangement may be encased, or it may be open as shown in the illustrated embodiment. The chassis could include an extraction fan arrangement, alternatively the fan could be mounted on the energy source head in order to disperse fumes.

In the illustrated embodiment, the role of the chassis 3 is to provide a track for the laser head to move along, in the ‘X’ and ‘Y’ axis of the 2-dimensional plane.

The power of the laser 2 does not have to be fixed and can typically vary from anywhere between 0.2 W and 3 W.

The power of the laser can be controlled using PWM (pulse width modulation) by the onboard microcontroller that controls other settings too, such as the path of the laser head, the power of the laser beam and the speed of the movement.

The swell of the microcapsule paper can be controlled using multiple factors which include but are not limited to; (1) the power of the laser 2, (2) the distance between the laser 2 and the microcapsule paper 1, (3) the focal length of the laser lens, (4) the time the laser beam is focused on one spot on the microcapsule paper 1.

The path of the laser 2 is controlled by the onboard microcontroller and varies depending on the path of the diagram and/or image you intend on creating a tactile version of.

The tactile diagram and/or image can comprise of diagrams, figures, axis, braille, shapes and alphanumeric characters.

As shown in FIG. 4 the alcohol microbubbles 6 within the microcapsule paper have not expanded. Hence the surface of the microcapsule paper 4 is of even level, before being exposed to a laser beam.

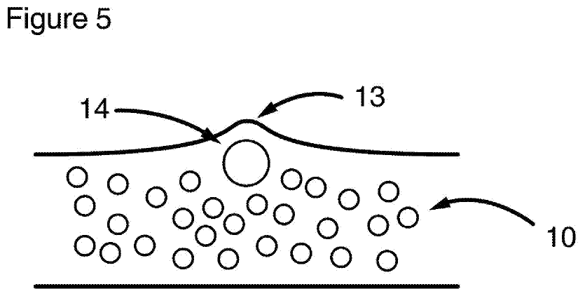

In FIG. 5 an alcohol microbubble 14 has expanded as it was exposed to the heat of a laser beam as shown in FIG. 4 label 8, hence creating a lifted/tactile path, as shown in FIG. 5 label 13.

When exposed to heat, the microbubbles as shown in FIG. 5 label 10 may expand or burst, hence ‘raising’ the surface, as shown in FIG. 5 label 13, this causes a permanently raised surface.

Although the present invention has been illustrated and described with reference to preferred embodiments and specific examples thereof, it is apparent to those of ordinary skill in the art that other embodiments and examples may perform similar functions and/or achieve like results. All such equivalent embodiments and examples are within the spirit and scope of the present invention.

What we claim is:

1. A novel method for tactile printing by the direct interaction of heat sensitive paper and a focused energy beam; the method comprising of
Providing singular or multiple laser heads, connected to a movable track with 2 degrees of freedom on the x-y plane so as to align the laser beam with the specific location on the paper desired to be ‘raised’;
The laser head moves along the track in the desired pattern as inputted through the software interface.

2. As per claim 1, an alternative embodiment of the method comprises of
Providing singular or multiple laser heads in a fixed position, interacting with heat sensitive paper connected to a movable track with 2 degrees of freedom on the x-y plane so as to align the paper's specific location desired to be ‘raised’ with the laser beam;
The paper moves along the track in the desired pattern as inputted through the software interface.

3. As per claim 1 and claim 2, a method of controllably raising the surface at specific locations of a heat sensitive paper, such as micro-capsule paper; Each specific location in the direct line of sight to an addressable, controllable focused energy beam in the form of laser beams of which the intensity and duration is controllable.

4. As per the method of claim 3, wherein successively applying more than one pulse of light directly to each of a plurality of predetermined spots forming the entirety of the tactile image on the paper.
